(19) United States
(12) Patent Application Publication
(10) Pub. No.: US 2025/0127228 A1
(43) Pub. Date: Apr. 24, 2025

(54) AEROSOL PROVISION DEVICE

(71) Applicant: NICOVENTURES TRADING LIMITED, London (GB)

(72) Inventors: Conor MCGRATH, London (GB); Matthew HOLDEN, London (GB); Jorge GOMEZ, London (GB)

(21) Appl. No.: 18/722,015

(22) PCT Filed: Dec. 19, 2022
(86) PCT No.: PCT/EP2022/086705

§ 371 Date: Jun. 20, 2024

(30) Foreign Application Priority Data
Dec. 22, 2021 (GB) 2118822.2

(51) Int. Cl. A24F 40/465; A24F 40/20; H05B 6/10

(52) U.S. Cl. CPC A24F 40/465; A24F 40/20; H05B 6/108

(57) ABSTRACT

An aerosol provision device generates an aerosol from aerosol-generating material. The device has a tubular member defining a heating chamber. The heating chamber is configured to receive an article containing aerosol-generating material. The tubular member has an inwardly projecting stop to limit insertion of the article. An aerosol generating system is also described, the system having an article that is receivable in the heating chamber of the device.

### Related Applications

The present application is a National Phase entry of PCT Application No. PCT/EP2022/086705 filed Dec. 19, 2022, which claims priority to GB Application No. 2118822.2 filed Dec. 22, 2021, each of which is hereby incorporated by reference in their entirety.

### TECHNICAL FIELD

The present invention relates to aerosol provision device for generating an aerosol from aerosol-generating material. The present invention also relates to an aerosol provision system comprising an aerosol provision device and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device for generating an aerosol from aerosol-generating material comprising a tubular member defining a heating chamber configured to receive at least a portion of an article containing aerosol-generating material, the tubular member comprising an inwardly projecting stop to limit insertion of the at least a portion of an article.

The inwardly projecting stop may be at an end portion of the tubular member.

The tubular member may have a first open end and a second open end, the first end defining an opening through which the at least a portion of an article is inserted into the heating chamber. The tubular member may be elongate.

The end portion may define the second open end. The inwardly projecting stop may be at the second open end.

The device may comprise a rim at the second open end, the stop being axially inset from the rim at the second open end.

The tubular member may comprise a side wall. The stop may be on or in an inner face of the side wall. The stop may project inwardly from and substantially perpendicular to the side wall of the tubular member. The stop may be formed from the side wall of the tubular member. The side wall and the stop may be formed as a one piece component. The stop may be formed from bend cutouts proximal the second open end.

The stop may comprise a flange, shoulder, step, tab or indent.

The stop may comprise a continuous protrusion extending circumferentially around an inner side of the tubular member.

The stop may be one of a plurality of stops. The plurality of stops may comprise a plurality of discontinuous stops. Adjacent stops may be circumferentially space from each other.

The tubular member may comprise first and second planar inner faces, each planar face comprising a stop.

The device may comprise a base to close the heating chamber. The base may define an end wall. The stop may be spaced from the end wall. The base may comprise an air outlet arranged to provide an air pathway. The base may define a cup.

The tubular member may be formed from a material heatable by penetration with a magnetic field. The tubular member may be a heating element.

In accordance with some embodiments herein, there is provided a susceptor for an aerosol generating device comprising a tubular side wall, the susceptor having a first open end portion for receiving at least a portion of an article containing aerosol-generating material, a second open end portion, and an inwardly depending stop at the second open end portion to limit insertion of the at least a portion of the article.

In accordance with some embodiments herein, there is provided a system comprising the aerosol generating device of any preceding claim and an article containing aerosol generating material, in which the article is at least partially receivable in the heating chamber of the aerosol generating device, and axial insertion of the article is limited by the stop.

The apparatus of these embodiments can include one or more, or all, of the features described above, as appropriate.

### BRIEF DESCRIPTION OF THE DRAWINGS

Embodiments will now be described, by way of example only, and with reference to the accompanying drawings in which:

FIG. 1 shows a schematic side view of an aerosol provision device;

FIG. 2 shows a longitudinal cross section of an aerosol generator of the aerosol provision device of FIG. 1;

FIG. 3 shows a tubular member defining a heating chamber of an aerosol generator of the device of FIG. 1;

FIG. 4 shows schematically a cross section of a portion of the tubular member of FIG. 3 and a base; and

FIG. 5 shows schematically a cross section of a portion of the tubular member of FIG. 3 and a base with an article received therein.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

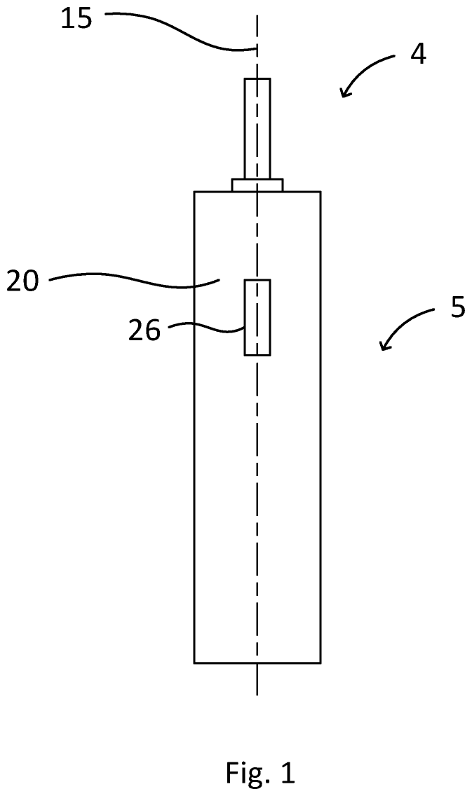

FIG. 1 shows an aerosol provision device 5. The device 5 can be part of a system 4 for generating aerosol from an aerosol generating material. The system comprises a replaceable article 10 comprising the aerosol generating material. The device 5 can be used to heat the replaceable article 10 comprising the aerosol generating material, to generate an aerosol or other inhalable material which can be inhaled by a user of the device 5.

The device 5 comprises a housing 20 which surrounds and houses various components of the device 5. The housing 20 is elongate. The device 5 has an opening 22 in one end, through which the article 10 can be inserted for heating by the device 5. The article may be fully or partially inserted into the device 5 for heating by the device 5.

The device 5 may comprise a user-operable control element 26, such as a button or switch, which operates the device 5 when operated, e.g. pressed. For example, a user may activate the device 5 by pressing the button 26.

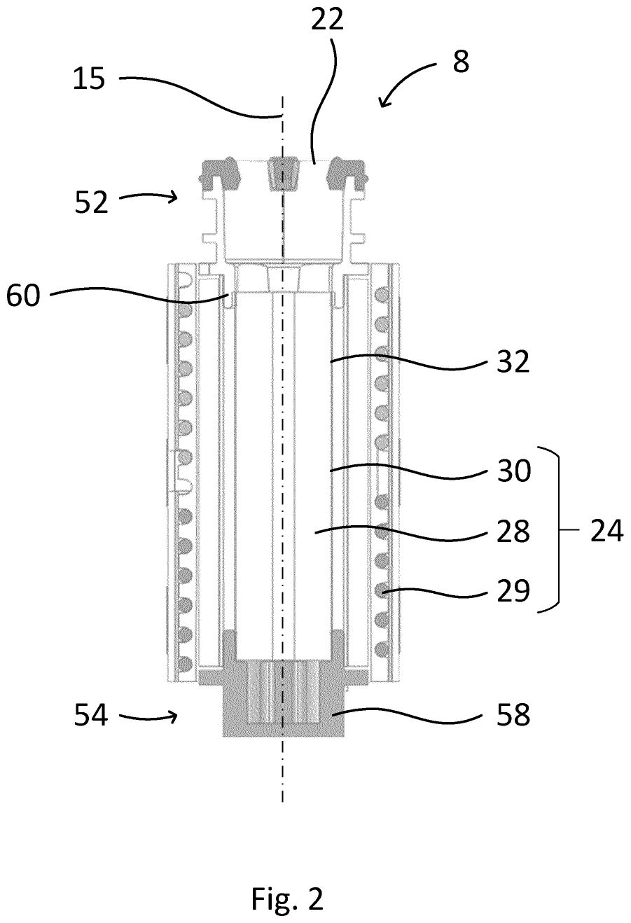

Referring to FIG. 2, the device 5 comprises an aerosol generator 8. The aerosol generator 8 defines a longitudinal axis 15, along which the article 10 may extend when inserted into the device 5. The opening is aligned on the longitudinal axis.

The aerosol generator 8 comprises various components for generating an aerosol from the received article. In one example, the article 10 is heated by a heater assembly 24 to generate aerosol. The opening 22 is in one end, through which the article may be inserted for heating. In use, the article 10 may be fully or partially inserted into the device where it may be heated by one or more components. The apparatus includes the heating assembly 24, a controller and a power source (not shown in figures). The heating assembly 24 is configured to heat the aerosol generating material of an article 10 inserted into the device 5, such that an aerosol is generated from the aerosol generating material. The power source supplies electrical power to the heating assembly 24, and the heating assembly converts the supplied electrical energy into heat energy for heating the aerosol generating material. The power source may, for example, be a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The power source may be electrically coupled to the heating assembly 24 to supply electrical power when required and under control of the controller to heat the aerosol generating material. The control circuit may be configured to activate and deactivate the heating assembly 24 based on a user operating the control element 26. For example, the controller may activate the heating assembly 24 in response to a user operating the button 26.

The end of the device 5 closest to the opening 22 may be known as the proximal end 52 of the device 5, as it is closest to the mouth of the user in use. In use, a user inserts an article 110 into the opening 22, operates the user control 22 to begin heating the aerosol generating material, and draws on the aerosol generated in the device 5. This causes aerosol to flow through the article 10 along a flow path towards the proximal end 52 of the device 5.

The other end of the device furthest away from the opening 22 may be known as the distal end 54 of the device 5, as it is the end furthest away from the mouth of the user in use. The terms proximal and distal as applied to the features of the device 5 will be described by reference to the relative positioning of such feature with respect to each other in a proximal-distal direction along the axis 15.

The aerosol generator 8 comprises an induction-type heater, including a magnetic field generator. The magnetic field generator comprises an inductor coil 29. The aerosol generator 8 comprises a heating element. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The heating assembly 24 comprises various component to heat the aerosol generating material of the article 10 via an inductive heating process. Induction heating is a process of heating an electrically conducting heating element by electromagnetic induction. In this embodiment, the heating element is the tubular member 30. An induction heating assembly may comprise the inductor coil 29, acting as an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitable positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The heating assembly 24 comprises the tubular member 30. The tubular member defines a heating chamber 28. The tubular member 30 acts as a receptacle to receive at least a portion of the article 10. The tubular member 30 is a heating element configured to heat the heating chamber 28. In other embodiments the heating element and the tubular member 30 may be separate components. Such a heating element extends axially within the tubular member 30. The heating element in such embodiments protrudes in the heating chamber 28. The heating element protrudes into the heating zone from the distal end. The heating element upstands in the receptacle.

The tubular member 30 acting as the heating element is heatable by penetration with a varying magnetic field. The tubular member 30 comprises electrically conducting material suitable for heating by electromagnetic induction. For example, the tubular member 30 may be formed from a carbon steel. It will be understood that other suitable materials may be used, for example a ferromagnetic material such as iron, nickel or cobalt.

The inductor coil is a helical coil, however other arrangements are envisaged. In embodiments, the number of inductor coils differs. In embodiments, the inductor coil 29 comprises two or more coils. The two or more coils in the embodiments are dispose adjacent to each other and may be aligned co-axially along the axis 15.

In some examples, in use, the inductor coil is configured to heat the heating element to a temperature of between about 200° C. and about 350° C., such as between about 240° C. and about 300° C., or between about 250° C. and about 280° C.

The inductor coil 29 is disposed external to the heating chamber 28. The inductor coil 29 encircles the heating chamber 28. The inductor coil 29 is configured to generate a varying magnetic field that penetrates the tubular member 30. The inductor coil 29 is arranged coaxially with the heating chamber 28.

In use, alternating current is supplied to the inductor coil 29 by the power source. The alternating current in the inductor coil 29 generates a varying magnetic flux adjacent to the heating element. The magnetic flux generates a current in the heating element, which in turn causes the heating element to heat.

The heating chamber 28 is configured and dimensioned to receive the article 10 to be heated. The heating chamber 28 defines a heating zone. In the present example, the article 10 is generally cylindrical, and the heating chamber 28 is dimensioned to receive the article 10. A sealing member 60 holds the heating chamber 28 in place in the device. The sealing member 60 provides a seal between the tubular member 30 and the rest of the device 5.

The receptacle comprises the tubular member 30 and a base 58. In this embodiment the tubular member 30 is the heating element. The heating chamber 28 is defined by a side wall 32 of the tubular member 30 and a base wall. The base wall is formed by the base 58. The side wall 32 of the tubular member 30 extends axially within the heating chamber 28 and upstands from the base 58. The tubular member is elongate. The base 58 is at the distal end 54 of the device 5. In this embodiment, the base 58 and the tubular member 30 are separate components. In other embodiments, the tubular member and base may be a one-piece component to define the heating chamber 28. The tubular member 30 and the base 58 may be made of different materials or the same material. The base 58 attaches to the distal end 54 of the tubular member 30 to form the heating chamber 28. The attachment between the base 58 and the tubular member 30 may be such that air can flow into the heating chamber form gaps between the side wall 32 and the base 58. The base 58 may comprise an air outlet arranged to provide an air pathway into the heating chamber 28.

The side wall 32 of the tubular member 30 extends axially within the device from the base 58 at the distal end 54 towards the opening 22 of the device 5 at the proximal end 52. The heating chamber 28 is open at the proximal end 52 to receive the article 10 through the opening 22 of the device 5. The tubular member 30 extends along and around and substantially coaxial with the longitudinal axis 15 of the device 5.

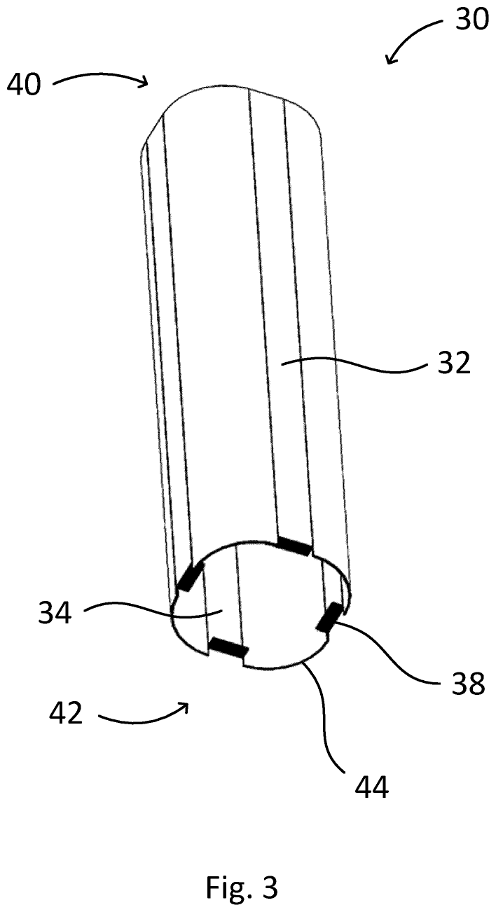

FIG. 3 shows the tubular member 30. The tubular member 30 has a first open end 40 and a second open end 42. The first end 40 defines an opening through which the article 10 is inserted into the heating chamber 28. The side wall 32 of the tubular member 30 has at least one inner face 34. In the embodiment of FIG. 3, the tubular member 30 has four inner faces 34. The inner face may be planar or have non planar shapes such as arcuate. One or more of the faces may be convex. In other embodiments the tubular member may have a circular, square or polygonal cross section.

The tubular member 30 may have an inconsistent diameter, perpendicular to the axis, around the circumference of the side wall 32. In other embodiments the tubular member 30 may have a consistent diameter around the circumference of the side wall 32.

The tubular member 30 has an inwardly projecting stop 38 at the second end 42. The stop 38 is on the inner faces 34 of the tubular member 30. In this embodiment, the tubular member comprises four stops 38, with each inner face 34 having a corresponding stop 38. The stops 38 form a stop configuration. In other embodiments, the number of stops may correspond to the number of inner faces. In other embodiments, the number of stops may be less than the number of inner faces. In other embodiments the number of stops may be more than the number of inner faces. The stops 38 project away from the inner faces 34 and into the heating chamber 28. The stops 38 may project inwardly from and substantially perpendicular to the inner faces 34 of the tubular member 30.

The sidewall 32 of the tubular member 30 terminates in an end wall or rim 44. The stops 38 are axially inset from the rim 44. The stop 38 axially limits insertion of the article 10 into the heating chamber 28 along the axis 15. On insertion of the article 10 into the heating chamber 28, the article does not protrude past the rim 44 and out of the second end 42 of the tubular member 30. In this embodiment, the stops 38 are formed from bent cut-outs proximal the second end 42. The cut-outs are bent to form tabs that protrude into the heating chamber 28 to contact the article 10 in use. The stops 38 are formed from the side wall of the tubular member. The stops 38 form a one-piece component with the tubular member 30.

Each stop 38 is circumferentially spaced from its adjacent stop 38. The stops 38 are discontinuous. The tubular member 30 of FIG. 3 has four planar inner faces 34, each planar face having a stop 38. In other embodiments the tubular member may have a different number of inner faces. The faces may be planar or non-planar. Each inner face has a corresponding stop depending inwardly therefrom. The plurality of stops may be diametrically opposite from one another.

The stops 38 depend inwardly such that at the location of the stops 38, the diameter of the tubular member 30 is partially narrowed such that on insertion of the article 10, the stops 38 contact the article to axially limit insertion of the article 10. The diameter of the tubular member 30 at diametrically opposing stops 38 is less that the diameter of the article 10 to be inserted.

In other embodiments the stop may be a flange, shoulder, step, tab or indent located at or proximate the second end. The stop may be formed from the tubular member 30. The stop may be formed separately to the tubular member and attached thereafter. The stop may form a one-piece component with the tubular member.

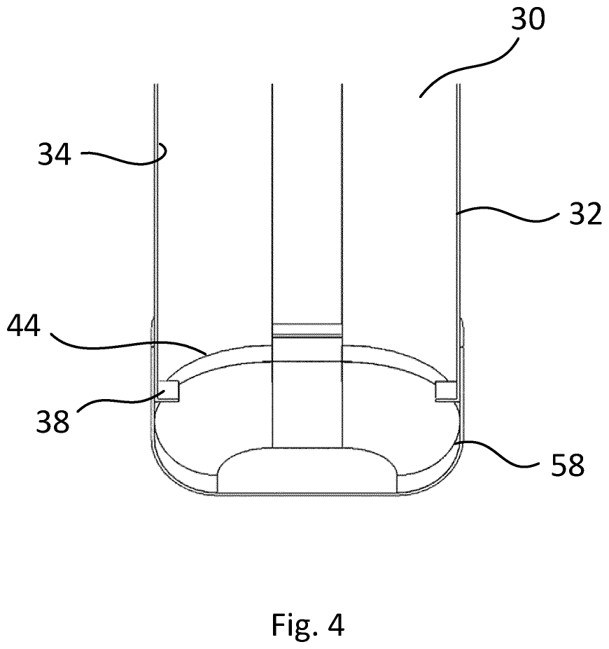

FIG. 4 shows a cross section of the second end 42 of the tubular member 30 with the base 58 attached. The base 58 closes the heating chamber 58. The base 58 defines an end wall from which the stops 38 are axially spaced. Air flows between the tubular member 30 and the article 10 to the base 58. The air flow then passes into the distal end of the article 10. The stops 38 space the distal end of the article 10 from the base 58 to provide for an air flow path. In embodiments, the base 58 has an air inlet arranged to provide an air pathway through the aerosol generator 8 and the device 5. The base 58 attaches around the outer edge of the side wall 32 of the tubular member 30. The base 58 is spaced from the article 10 by the stops. The base 58 overlaps the tubular member 30.

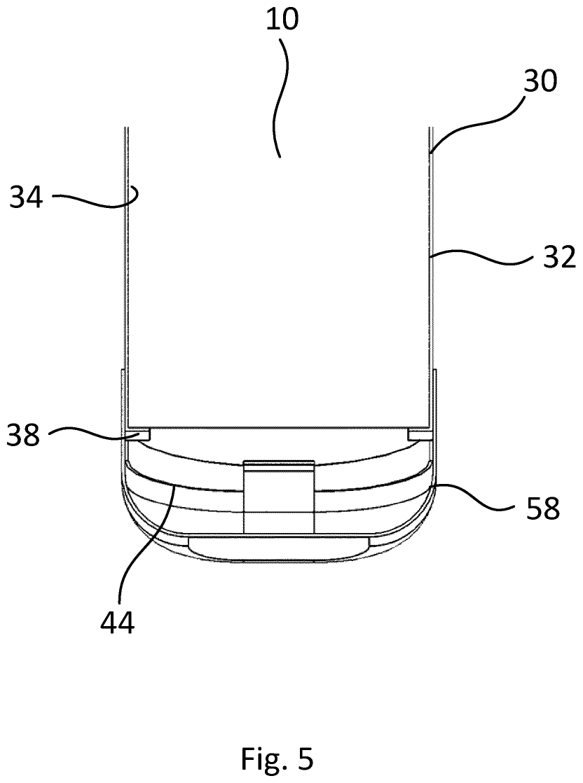

FIG. 5 shows a cross section of the second end 42 of the tubular member 30 with the base 58 attached and the article 10 inserted. The article 10 is inserted into the heating chamber 28 through the tubular member 30 such that the article 10 contacts the inner faces 34 of the tubular member 30. The inner faces 34 locate the article 10 concentrically within the tubular member 30 and therefore concentrically within the heating chamber 28. The inner faces 34 interact with the article 10 such as to provide a push fit with the article 10 within the heating chamber 28. On insertion of the article 10 into the heating chamber 28, the stops 38 contact the article 10 to limit insertion of the article 10 into the tubular member 30. This gives the user tactile feedback as to when the article 10 is inserted far enough. It also prevents the user inserting the article 10 too far and therefore damaging the article 10 or the heating chamber 28. The stops 38 ensure the article 10 is correctly axially located within heating chamber 28. The article 10 is never inserted axially further than the rim 44 at the second end 42 due to the presence of the stops 38.

In some embodiments, such as the one in FIGS. 3 to 5, the stop is a plurality of discontinuous stops. In other embodiments the stops may be continuous. The continuous stop comprises a continuous protrusion extending circumferentially around the inside of the tubular member 30. The continuous stop extends inwardly from the inner faces of the tubular member 30 to limit the axial insertion of the article. The continuous stop may have different radial widths throughout the circumference of the stop, or the radial width may be constant.

In the above described embodiments, the heating arrangement is an inductive heating arrangement. In embodiments, other types of heating arrangement are used, such as resistive heating. The configuration of the device is generally as described above and so a detailed description will be omitted. In such arrangements the heating assembly 24 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device for generating an aerosol from aerosol-generating material comprising:
a tubular member defining a heating chamber configured to receive at least a portion of an article containing aerosol-generating material;
the tubular member comprising an inwardly projecting stop to limit insertion of the at least a portion of an article.

2. The aerosol provision device of claim 1, wherein the inwardly projecting stop is at an end portion of the tubular member.

3. The aerosol provision device of claim 1, wherein the tubular member has a first open end and a second open end, the first end defining an opening through which the at least a portion of an article is inserted into the heating chamber.

4. The aerosol provision device of claim 3, wherein the end portion defines the second open end.

5. The aerosol provision device of claim 3, wherein the inwardly projecting stop is at the second open end.

6. The aerosol provision device of claim 3, comprising a rim at the second open end, wherein the stop is axially inset from the rim at the second open end.

7. The aerosol provision device of claim 1, wherein the tubular member comprises a side wall.

8. The aerosol provision device of claim 7, wherein the stop is on or in an inner face of the side wall.

9. The aerosol provision device of claim 7, wherein the stop projects inwardly from and substantially perpendicular to the side wall of the tubular member.

10. The aerosol provision device of claim 7, wherein the stop is formed from the side wall of the tubular wall.

11. The aerosol provision device of claim 10, wherein the stop is formed from a bent cut out proximal the second open end.

12. The aerosol provision device of claim 1, wherein the stop is one of a plurality of stops.

13. The aerosol provision device of claim 12, wherein the plurality of stops 13. comprises a plurality of discontinuous stops.

14. The aerosol provision device of claim 1, comprising a base to close the heating chamber.

15. The aerosol provision device of claim 14, wherein the base defines an end wall.

16. The aerosol provision device of claim 15, wherein the stop is spaced from the end wall.

17. The aerosol provision device of claim 14, wherein the base comprises an air outlet arranged to provide an air pathway.

18. The aerosol provision device of claim 1, wherein the tubular member is formed from a material heatable by penetration with a magnetic field.

19. A susceptor for an aerosol provision device comprising a tubular sidewall, the susceptor having a first open end portion for receiving at least a portion of an article containing aerosol generating material, a second open end portion, and an inwardly depending stop at the second open end portion to limit insertion of the at least a portion of an article.

20. A system comprising the aerosol provision device of claim 1 and an article containing aerosol generating material, in which the article is at least partially receivable in the heating chamber of the aerosol provision device, and axial insertion of the article is limited by the stop.
